(19) United States
(12) Patent Application Publication
(10) Pub. No.: US 2025/0274573 A1
(43) Pub. Date: Aug. 28, 2025

(54) APPARATUS AND METHOD OF PROCESSING IMAGE, DISPLAY DEVICE, ELECTRONIC DEVICE, AND STORAGE MEDIUM

(71) Applicants: Beijing BOE Display Technology Co., Ltd., Beijing (CN); BOE Technology Group Co., Ltd., Beijing (CN); Beijing BOE Technology Development Co., Ltd., Beijing (CN)

(72) Inventors: Xing Zhou, Beijing (CN); Hongchuan Du, Beijing (CN); Jianbo Wang, Beijing (CN); Tianhui Zhao, Beijing (CN); Heyang Zhang, Beijing (CN); Yue Guo, Beijing (CN); Liangliang Ren, Beijing (CN)

(21) Appl. No.: 18/727,819

(22) PCT Filed: May 17, 2023
(86) PCT No.: PCT/CN2023/094704

§ 371 Date: Jul. 10, 2024

(51) Int. Cl. H04N 13/122; G06V 10/75; H04N 13/351

(52) U.S. Cl. CPC H04N 13/122; G06V 10/751; H04N 13/351

(57) ABSTRACT

An apparatus and method of processing an image, a display device, an electronic device, and a storage medium are provided. The apparatus of processing the image includes: an acquisition unit used to acquire multi-view images; an adjustment unit used to adjust a pixel grayscale value of at least one target pixel in at least one target region in the multi-view images according to a predetermined mapping relationship, so as to obtain adjusted multi-view images, where the predetermined mapping relationship is obtained by measuring a ghosting sensitivity of a display apparatus; and an output unit used to obtain, according to the adjusted multi-view images, a processed image for displaying on the display apparatus, and output the processed image.

### CROSS-REFERENCE TO RELATED APPLICATION(S)

This application is a Section 371 National Stage Application of International Application No. PCT/CN2023/094704, filed on May 17, 2023, entitled “APPARATUS AND METHOD OF PROCESSING IMAGE, DISPLAY DEVICE, ELECTRONIC DEVICE, AND STORAGE MEDIUM”, the content of which is incorporated herein by reference in its entirety.

### TECHNICAL FIELD

The present disclosure relates to the field of image processing technology, and specifically to an apparatus and method of processing an image, a display device, an electronic device, and a storage medium.

### BACKGROUND

With the development of information science and technology, display technology has also made progress. Naked-eye 3D technology is a display technology that may achieve a stereoscopic vision without the help of external tools such as polarized glasses. The naked-eye 3D technology may provide users with a three-dimensional visual experience and an immersive sense, which may bring users a new visual experience. The naked-eye 3D technology is a significant breakthrough in the field of display technology, which improves a visual effect.

A crosstalk rate is an important indicator to evaluate a naked-eye display effect. It is generally considered that if the crosstalk rate is greater than 2%, ghosting may begin to be perceived, and when the crosstalk rate is greater than 10%, noticeable ghosting may be perceived. For a naked-eye 3D display apparatus, it is difficult to reduce the crosstalk rate, which involves improving a design parameter of the naked-eye 3D display apparatus. Therefore, it is difficult to improve ghosting of a naked-eye 3D display apparatus by reducing the crosstalk rate.

### SUMMARY

In view of this, the present disclosure provides an apparatus and method of processing an image, a display device, an electronic device, and a storage medium.

In an aspect of the present disclosure, an apparatus of processing an image is provided, including: an acquisition unit configured to acquire multi-view images; an adjustment unit configured to adjust a pixel grayscale value of at least one target pixel in at least one target region in the multi-view images according to a predetermined mapping relationship, so as to obtain adjusted multi-view images, where the predetermined mapping relationship is obtained by measuring a ghosting sensitivity of a display apparatus; and an output unit configured to obtain, according to the adjusted multi-view images, a processed image for displaying on the display apparatus, and output the processed image.

For example, the multi-view images include a first viewpoint image and a second viewpoint image adjacent to the first viewpoint image, the first viewpoint image contains N pixels, the second viewpoint image contains N pixels, and N is an integer greater than 1; and the apparatus further includes a first determination unit configured to: determine a first region in the first viewpoint image and a second region corresponding to the first region in the second viewpoint image according to difference values between grayscale values of the N pixels of the first viewpoint image and grayscale values of the N pixels of the second viewpoint image, and determine the first region and the second region as the at least one target region.

For example, the first determination unit being configured to determine a first region in the first viewpoint image and a second region corresponding to the first region in the second viewpoint image according to difference values between grayscale values of the N pixels of the first viewpoint image and grayscale values of the N pixels of the second viewpoint image includes: determining the difference values between the grayscale values of the N pixels of the first viewpoint image and the grayscale values of the N pixels of the second viewpoint image to obtain N difference values; and determining the first region in the first viewpoint image and the second region corresponding to the first region in the second viewpoint image according to the N difference values, where the first region and the second region each contain n adjacent pixels, each of the difference values between the pixel values of the n pixels in the first region and the pixel values of the n pixels in the second region is greater than or equal to a predetermined difference threshold value, and n is greater than or equal to a predetermined number-of-pixels threshold value and less than N.

For example, the multi-view images include M viewpoint images, M is an integer greater than 2; each of the M viewpoint images contains N pixels; and the apparatus further includes a second determination unit configured to: determine an m^{th} region in an m^{th} viewpoint image and an (m+1)^{th} region corresponding to the m^{th} region in an (m+1)^{th} viewpoint image according to difference values between the grayscale values of the N pixels of the m^{th} viewpoint image and the grayscale values of the N pixels of the (m+1)^{th} viewpoint image, and determine the m^{th} region and the (m+1)^{th} region as the at least one target region, so as to obtain an adjusted m^{th} viewpoint image and an adjusted (m+1)^{th} viewpoint image, where m is greater than or equal to 1 and less than or equal to M−2; and determine an adjusted (m+1)^{th} region in the adjusted (m+1)^{th} viewpoint image and an (m+2)^{th} region corresponding to the adjusted (m+1)^{th} region in an (m+2)^{th} viewpoint image according to difference values between the grayscale values of the N pixels of the adjusted (m+1)^{th} viewpoint image and the grayscale values of the N pixels of the (m+2)^{th} viewpoint image, and determine the adjusted (m+1)^{th} region and the (m+2)^{th} region as the at least one target region.

For example, the second determination unit being configured to determine an m^{th} region in an m^{th} viewpoint image and an (m+1)^{th} region corresponding to the m^{th} region in an (m+1)^{th} viewpoint image according to difference values between the grayscale values of the N pixels of the m^{th} viewpoint image and the grayscale values of the N pixels of the (m+1)^{th} viewpoint image includes: determining the difference values between the grayscale values of the N pixels of the m^{th} viewpoint image and the grayscale values of the N pixels of the (m+1)^{th} viewpoint image to obtain N difference values; and determining the m^{th} region in the m^{th} viewpoint image and the (m+1)^{th} region corresponding to the m^{th} region in the (m+1)^{th} viewpoint image according to the N difference values, where the m^{th} region and the (m+1)^{th} region each contain n adjacent pixels, each of the difference values between the pixel values of the n pixels in the m^{th} region and the pixel values of the n pixels in the (m+1)^{th} region is greater than or equal to a predetermined difference threshold value, and n is greater than or equal to a predetermined number-of-pixels threshold value and less than N.

For example, the adjustment unit being configured to adjust a pixel grayscale value of at least one target pixel in at least one target region includes: adjusting the grayscale value of the at least one target pixel to a first threshold value in response to determining that the grayscale value of the at least one target pixel is less than or equal to the first threshold value; adjusting the grayscale value of the at least one target pixel to a first target value in response to determining that the grayscale value of the at least one target pixel is greater than the first threshold value and less than or equal to a second threshold value, where the first target value is determined according to the first threshold value and the second threshold value; and keeping the grayscale value of the at least one target pixel unchanged in response to determining that the grayscale value of the at least one target pixel is greater than the second threshold value, where the first threshold value and the second threshold value are determined according to the predetermined mapping relationship.

For example, the adjustment unit being configured to adjust a pixel grayscale value of at least one target pixel in at least one target region includes: adjusting the grayscale value of the at least one target pixel to a third threshold value in response to determining that the grayscale value of the at least one target pixel is greater than or equal to the third threshold value; adjusting the grayscale value of the at least one target pixel to a second target value in response to determining that the grayscale value of the at least one target pixel is less than the third threshold value and greater than or equal to a fourth threshold value, where the second target value is determined according to the third threshold value and the fourth threshold value; and keeping the grayscale value of the at least one target pixel unchanged in response to determining that the grayscale value of the at least one target pixel is less than the fourth threshold value, where the third threshold value and the fourth threshold value are determined according to the predetermined mapping relationship.

For example, the output unit being configured to obtain, according to the adjusted multi-view images, a processed image for displaying on the display apparatus includes: concatenating the adjusted multi-view images to obtain the processed image for displaying on the display apparatus.

For example, the predetermined mapping relationship includes a mapping relationship between the grayscale values of the pixels in the target region and a plurality of threshold values, the grayscale values of the pixels includes a maximum grayscale value, a minimum grayscale value and an average grayscale value of the pixels in the target region, and the plurality of threshold values include a first threshold value, a second threshold value, a third threshold value and a fourth threshold value.

In another aspect of the present disclosure, a display device is provided, including: the apparatus of processing the image as described above; and a display apparatus configured to display an output image from the apparatus of processing the image.

In another aspect of the present disclosure, a method of processing an image is provided, including: acquiring multi-view images; adjusting a pixel grayscale value of at least one target pixel in at least one target region in the multi-view images according to a predetermined mapping relationship, so as to obtain adjusted multi-view images, where the predetermined mapping relationship is obtained by measuring a ghosting sensitivity of a display apparatus; obtaining, according to the adjusted multi-view images, a processed image for displaying on the display apparatus; and outputting the processed image.

For example, the multi-view images include a first viewpoint image and a second viewpoint image adjacent to the first viewpoint image, the first viewpoint image contains N pixels, the second viewpoint image contains N pixels, and N is an integer greater than 1; and the method further includes: determining a first region in the first viewpoint image and a second region corresponding to the first region in the second viewpoint image according to difference values between grayscale values of the N pixels of the first viewpoint image and grayscale values of the N pixels of the second viewpoint image; and determining the first region and the second region as the at least one target region.

For example, the determining a first region in the first viewpoint image and a second region corresponding to the first region in the second viewpoint image according to difference values between grayscale values of the N pixels of the first viewpoint image and grayscale values of the N pixels of the second viewpoint image includes: determining the difference values between the grayscale values of the N pixels of the first viewpoint image and the grayscale values of the N pixels of the second viewpoint image to obtain N difference values; and determining the first region in the first viewpoint image and the second region corresponding to the first region in the second viewpoint image according to the N difference values, where the first region and the second region each contain n adjacent pixels, each of the difference values between the pixel values of the n pixels in the first region and the pixel values of the n pixels in the second region is greater than or equal to a predetermined difference threshold value, and n is greater than or equal to a predetermined number-of-pixels threshold value and less than N.

For example, the multi-view images include M viewpoint images, M is an integer greater than 2; each of the M viewpoint images contains N pixels; and the method further includes: determining an m^{th} region in an m^{th} viewpoint image and an (m+1)^{th} region corresponding to the m^{th} region in an (m+1)^{th} viewpoint image according to difference values between the grayscale values of the N pixels of the m^{th} viewpoint image and the grayscale values of the N pixels of the (m+1)^{th} viewpoint image, and determining the m^{th} region and the (m+1)^{th} region as the at least one target region, so as to obtain an adjusted m^{th} viewpoint image and an adjusted (m+1)^{th} viewpoint image, where m is greater than or equal to 1 and less than or equal to M−2; and determining an adjusted (m+1)^{th} region in the adjusted (m+1)^{th} viewpoint image and an (m+2)^{th} region corresponding to the adjusted (m+1)^{th} region in an (m+2)^{th} viewpoint image according to difference values between the grayscale values of the N pixels of the adjusted (m+1)^{th} viewpoint image and the grayscale values of the N pixels of the (m+2)^{th} viewpoint image, and determining the adjusted (m+1)^{th} region and the (m+2)^{th} region as the at least one target region.

For example, the determining an m^{th} region in an m^{th} viewpoint image and an (m+1)^{th} region corresponding to the m^{th} region in an (m+1)^{th} viewpoint image according to difference values between the grayscale values of the N pixels of the m^{th} viewpoint image and the grayscale values of the N pixels of the (m+1)^{th} viewpoint image includes: determining the difference values between the grayscale values of the N pixels of the m^{th} viewpoint image and the grayscale values of the N pixels of the (m+1)^{th} viewpoint image to obtain N difference values; and determining the m^{th} region in the m^{th} viewpoint image and the (m+1)^{th} region corresponding to the m^{th} region in the (m+1)^{th} viewpoint image according to the N difference values, where the m^{th} region and the (m+1)^{th} region each contain n adjacent pixels, each of the difference values between the pixel values of the n pixels in the m^{th} region and the pixel values of the n pixels in the (m+1)^{th} region is greater than or equal to a predetermined difference threshold value, and n is greater than or equal to a predetermined number-of-pixels threshold value and less than N.

For example, the adjusting a pixel grayscale value of at least one target pixel in at least one target region includes: adjusting the grayscale value of the at least one target pixel to a first threshold value in response to determining that the grayscale value of the at least one target pixel is less than or equal to the first threshold value; adjusting the grayscale value of the at least one target pixel to a first target value in response to determining that the grayscale value of the at least one target pixel is greater than the first threshold value and less than or equal to a second threshold value, where the first target value is determined according to the first threshold value and the second threshold value; and keeping the grayscale value of the at least one target pixel unchanged in response to determining that the grayscale value of the at least one target pixel is greater than the second threshold value, where the first threshold value and the second threshold value are determined according to the predetermined mapping relationship.

For example, the adjusting a pixel grayscale value of at least one target pixel in at least one target region includes: adjusting the grayscale value of the at least one target pixel to a third threshold value in response to determining that the grayscale value of the at least one target pixel is greater than or equal to the third threshold value; adjusting the grayscale value of the at least one target pixel to a second target value in response to determining that the grayscale value of the at least one target pixel is less than the third threshold value and greater than or equal to a fourth threshold value, where the second target value is determined according to the third threshold value and the fourth threshold value; and keeping the grayscale value of the at least one target pixel unchanged in response to determining that the grayscale value of the at least one target pixel is less than the fourth threshold value, where the third threshold value and the fourth threshold value are determined according to the predetermined mapping relationship.

For example, the obtaining, according to the adjusted multi-view images, a processed image for displaying on the display apparatus includes: concatenating the adjusted multi-view images to obtain the processed image for displaying on the display apparatus.

For example, the predetermined mapping relationship includes a mapping relationship between the grayscale values of the pixels in the target region and a plurality of threshold values, the grayscale values of the pixels includes a maximum grayscale value, a minimum grayscale value and an average grayscale value of the pixels in the target region, and the plurality of threshold values include a first threshold value, a second threshold value, a third threshold value and a fourth threshold value.

In another aspect of the present disclosure, an electronic device is provided, including: at least one processor; and a memory for storing instructions executable by the at least one processor, where the instructions are configured to, when executed by the at least one processor, cause the at least one processor to implement the method as described above.

In another aspect of the present disclosure, a non-transitory computer-readable storage medium having computer instructions therein is provided, where the computer instructions are configured to cause a computer to implement the method as described above.

In another aspect of the present disclosure, a computer program product containing a computer program is provided, where the computer program is configured to, when executed by a processor, causes the processor to implement the method as described above.

It should be understood that content described in this section is not intended to identify key or important features in embodiments of the present disclosure, nor is it intended to limit the scope of the present disclosure. Other features of the present disclosure will be easily understood through the following description

### BRIEF DESCRIPTION OF THE DRAWINGS

The accompanying drawings are used for a better understanding of the solutions and do not constitute a limitation to the present disclosure. In the accompanying drawings:

FIG. 1 shows a block diagram of an apparatus of processing an image according to embodiments of the present disclosure;

FIG. 2 shows a mapping relationship curve according to embodiments of the present disclosure;

FIG. 3 shows a process of an apparatus of processing an image adjusting multi-view images in a case that the multi-view images include two adjacent viewpoint images according to embodiments of the present disclosure;

FIG. 4 shows a process of an apparatus of processing an image adjusting multi-view images in a case that the multi-view images include at least three viewpoint images according to embodiments of the present disclosure;

FIG. 5 shows an image displayed by a display apparatus according to embodiments of the present disclosure;

FIG. 6 shows a flowchart of a method of processing an image according to embodiments of the present disclosure; and

FIG. 7 shows a block diagram of an electronic device suitable for implementing a method of processing an image according to embodiments of the present disclosure.

### DETAILED DESCRIPTION OF EMBODIMENTS

In order to make objectives, technical solutions and advantages of the present disclosure clearer, the technical solutions in embodiments of present disclosure are clearly and completely described below with reference to the accompanying drawings in embodiments of the present disclosure. Obviously, the described embodiments are only a part but not all of embodiments of the present disclosure. Based on the described embodiments of the present disclosure, all additional embodiments obtained by those ordinary skilled in the art without carrying out inventive effort fall within the protection scope of the present disclosure. It should be noted that throughout the drawings, the same elements are represented by the same or similar reference numerals. In the following descriptions, some specific embodiments are only used for descriptive purposes and should not be construed as limiting the present disclosure, but rather examples of embodiments of the present disclosure. When it is possible to cause confusions in the understanding of the present disclosure, conventional structures or configurations will be omitted. It should be noted that the shape and size of each component in the figures do not reflect the actual size and ratio, but just illustrate the contents of embodiments of the present disclosure.

Unless otherwise defined, the technical or scientific terms used in embodiments of the present disclosure should have the usual meanings understood by those skilled in the art. The words “first,” “second,” and the like used in embodiments of the present disclosure do not indicate any order, quantity or importance, but are just used to distinguish different composition parts.

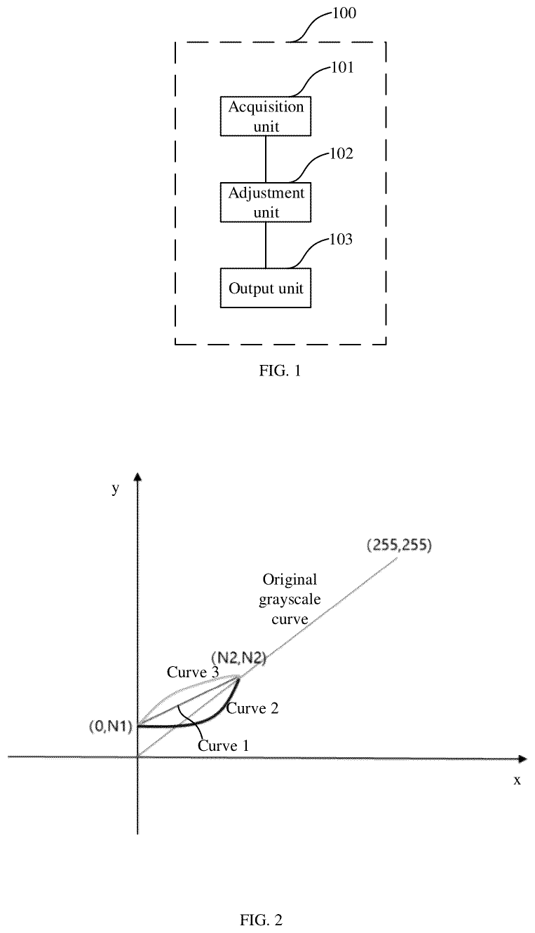

FIG. 1 shows a block diagram of an apparatus of processing an image according to embodiments of the present disclosure.

As shown in FIG. 1, an apparatus 100 of processing an image may include an acquisition unit 101, an adjustment unit 102 and an output unit 103.

The acquisition unit 101 may be used to acquire multi-view images. The adjustment unit 102 may be used to adjust a pixel grayscale value of at least one target pixel in at least one target region in the multi-view images according to a predetermined mapping relationship, so as to obtain adjusted multi-view images, where the predetermined mapping relationship is obtained by measuring a ghosting sensitivity of a display apparatus. The output unit 103 may be used to obtain, according to the adjusted multi-view images, a processed image for displaying on a display apparatus, and output the processed image.

According to embodiments of the present disclosure, the multi-view images include a plurality of viewpoint images. The plurality of viewpoint images have parallax with each other. The number of the plurality of viewpoint images may be determined according to actual service needs and is not limit here. For example, the number of the plurality of viewpoint images may be 2 or 9, etc.

According to embodiments of the present disclosure, a naked-eye 3D display apparatus may achieve a naked-eye 3D display effect by feeding two images having parallax into a left eye and a right eye respectively. Since the plurality of viewpoint images have parallax with each other, it is possible to achieve a naked-eye 3D display effect when two adjacent viewpoint images in the plurality of viewpoint images are fed into human eyes through the display apparatus.

According to embodiments of the present disclosure, the target region refers to a region in which two adjacent viewpoint images have a large difference in brightness at the same position.

According to embodiments of the present disclosure, the ghosting sensitivity refers to a crosstalk rate between a plurality of predetermined viewpoint images when the plurality of predetermined viewpoint images are simultaneously displayed on the display apparatus.

According to embodiments of the present disclosure, when two viewpoint images having parallax are fed to the left eye and the right eye respectively, a phenomenon where partial brightness of an image that should have entered the left eye enters the right eye or vice versa is referred to as a crosstalk. A left viewpoint image refers to a parallax image fed into the left eye, and a right viewpoint image refers to a parallax image fed into the right eye. The crosstalk rate refers to a proportion of the brightness of the left viewpoint image entering the right eye to an overall brightness entering the right eye.

According to embodiments of the present disclosure, the crosstalk rate between the plurality of predetermined viewpoint images may be obtained through a relevant test apparatus.

According to embodiments of the present disclosure, when the crosstalk rate between the plurality of predetermined viewpoint images and a brightness curve of various grayscales are obtained, it is possible to obtain, according to the crosstalk rate and the brightness curve, a grayscale corresponding to a brightness crosstalk from the left viewpoint image to the right viewpoint image in the plurality of predetermined viewpoint images. The predetermined mapping relationship may be obtained according to that grayscale.

According to embodiments of the present disclosure, for example, for a naked-eye 3D display apparatus having a crosstalk rate of 2%, a brightness of 250 nit corresponding to a grayscale of 255, and a brightness of 5 nit corresponding to a grayscale of 10, in a case that a pixel at any pixel position in the left viewpoint image has a grayscale of 255, the brightness crosstalk from the left viewpoint image to the right viewpoint image is 250*2%=5 nit, which corresponds to a grayscale of 10. Subsequently, it is possible to obtain the predetermined mapping relationship according to the grayscale of 10, and then adjust the pixel grayscale of the pixel having the pixel grayscale of 255 in the left viewpoint image and the pixel grayscale of a pixel in the right viewpoint image corresponding to that pixel, according to the mapping relationship.

According to embodiments of the present disclosure, the predetermined mapping relationship may be obtained by a mapping relationship equation constituted by the grayscale values of the pixels in the target region and a plurality of threshold values. The predetermined mapping relationship may include a linear mapping relationship and a curve mapping relationship.

According to embodiments of the present disclosure, a ghosting size is not only related to the crosstalk rate, but also to a magnitude of a brightness difference at the same position of parallax images, and the greater the difference, the greater the ghosting size. Therefore, the ghosting may be reduced by adjusting the brightness difference at the same position of the parallax images.

According to embodiments of the present disclosure, by acquiring the multi-view images using the acquisition unit, and then adjusting the pixel grayscale value of at least one target pixel in at least one target region in the multi-view images using the adjustment unit according to the predetermined mapping relationship so as to obtain the adjusted multi-view images, it is possible to adjust the target region having a large crosstalk rate and reduce the difference value between the corresponding pixel grayscale values of the left image and the right image in the target region in the multi-view images, so that the ghosting in the processed image obtained according to the adjusted multi-view images and output by the output unit may be reduced, and the display effect may be improved. Different from improving the ghosting of the naked-eye 3D display apparatus by reducing the crosstalk rate, there is no need to improve a design parameter of a naked-eye 3D display apparatus, and an efficiency of improving the ghosting of the naked-eye 3D display apparatus may be improved.

According to embodiments of the present disclosure, the predetermined mapping relationship includes a mapping relationship between the grayscale values of the pixels in the target region and a plurality of threshold values. The grayscale values of the pixels include a maximum grayscale value, a minimum grayscale value and an average grayscale value of the pixels in the target region. The plurality of threshold values include a first threshold value, a second threshold value, a third threshold value, and a fourth threshold value.

According to embodiments of the present disclosure, the predetermined mapping relationship is shown in Table 1.

TABLE 1

| Input Parameters | | | | | | |
|---|---|---|---|---|---|---|
| Minimum | Maximum | Average | Output parameters | | | |
| grayscale | grayscale | grayscale | N1 | N2 | N3 | N4 |
| 0 | 255 | 125 | 20 | 90 | 220 | 180 |
| . | . | . | . | . | . | . |
| . | . | . | . | . | . | . |
| . | . | . | . | . | . | . |
| 10 | 220 | 110 | 30 | 127 | 200 | 175 |
| . | . | . | . | . | . | . |
| . | . | . | . | . | . | . |
| . | . | . | . | . | . | . |

In Table 1, N1 represents the first threshold value, N2 represents the second threshold value, N3 represents the third threshold value, and N4 represents the fourth threshold value.

According to embodiments of the present disclosure, it is possible to obtain the minimum grayscale, the maximum grayscale and the average grayscale of the multi-view images by traversing all pixels of the multi-view images.

According to embodiments of the present disclosure, after the minimum grayscale, the maximum grayscale and the average grayscale of the multi-view images are obtained, the pixel grayscale value of the at least one target pixel in the at least one target region of the multi-view images may be adjusted according to the first threshold value N1, the second threshold value N2, the third threshold value N3 and the fourth threshold value N4 corresponding to the minimum grayscale, the maximum grayscale and the average grayscale, so as to obtain the adjusted multi-view images.

As shown in Table 1, when the multi-view images have the maximum grayscale value of 255, the minimum grayscale value of 0 and the average grayscale value of 125, the pixel grayscale values in the target region may be updated according to N1 of “20”, N2 of “90”, N3 of “220” and N4 of “180”. When the multi-view images have the maximum grayscale value of 220, the minimum grayscale value of 10 and the average grayscale value of 110, the pixel grayscale values in the target region may be updated according to N1 of “30”, N2 of “90”, N3 of “200” and N4 of “175”.

According to embodiments of the present disclosure, the maximum grayscale value, the minimum grayscale value and the average grayscale value of the multi-view images actually calculated may respectively have grayscale difference values with the maximum grayscale value, the minimum grayscale value and the average grayscale value in Table 1, and the grayscale difference value is less than or equal to a predetermined value. For example, if the predetermined value is 1, the actually calculated maximum grayscale value of the multi-view images is 249.5, the actually calculated minimum grayscale value of the multi-view images is 0.4, and the actually calculated average grayscale value of the multi-view images is 125.6, the pixel grayscale values in the target region may be updated according to N1 of “20”, N2 of “90”, N3 of “220” and N4 of “180”.

According to embodiments of the present disclosure, the adjustment unit adjusting the grayscale value of the at least one target pixel in the at least one target region according to the predetermined mapping relationship in Table 1 includes: adjusting the grayscale value of the at least one target pixel to a first threshold value in response to determining that the grayscale value of the at least one target pixel is less than or equal to the first threshold value; adjusting the grayscale value of the at least one target pixel to a first target value in response to determining that the grayscale value of the at least one target pixel is greater than the first threshold value and less than or equal to a second threshold value, where the first target value is determined according to the first threshold value and the second threshold value; and keeping the grayscale value of the at least one target pixel unchanged in response to determining that the grayscale value of the at least one target pixel is greater than the second threshold value. The first threshold value and the second threshold value are determined according to the predetermined mapping relationship.

According to embodiments of the present disclosure, by adjusting the grayscale value of the at least one target pixel to the first threshold value in response to determining that the grayscale value of the at least one target pixel is less than or equal to the first threshold value, it is possible to reduce a contrast of brightness at the same position of the parallax images by increasing the brightness of a low grayscale, and then the ghosting may be reduced when the parallax images are displayed on the display apparatus.

By adjusting the grayscale value of the at least one target pixel to the first target value determined according to the first threshold value and the second threshold value in response to determining that the grayscale value of the at least one target pixel is greater than the first threshold value and less than or equal to the second threshold value, it is possible to adjust the grayscale value of at least one target pixel through the first target value determined by the first threshold value and the second threshold value, so that the grayscale value greater than the first threshold value and less than or equal to the second threshold value may be adjusted to slowly change according to a certain pattern, then the contrast of brightness at the same position of the parallax images may be slowly reduced, and the ghosting may be reduced when the parallax images are displayed on the display apparatus.

FIG. 2 shows a mapping relationship curve according to embodiments of the present disclosure.

In a coordinate system shown in FIG. 2, an abscissa represents a pixel grayscale value of at least one target pixel in the target region, and an ordinate represents an adjusted pixel grayscale value.

As shown in FIG. 2, when no adjustment is performed on the pixel grayscale value of the at least one target pixel in the target region, the pixel grayscale value of the at least one target pixel in the target region remains unchanged. If it is determined that the grayscale value of the at least one target pixel is less than or equal to the first threshold value, the grayscale value of the at least one target pixel may be adjusted to the first threshold value N1. N1 is 0 in the example of FIG. 2, and may also be set to, for example, a value between 5 and 10, which is not limited here. In a case of adjusting the pixel grayscale value of the at least one target pixel in the target region in response to determining that the grayscale value of the at least one target pixel is greater than the first threshold value of 0 and less than or equal to the second threshold value N2, a change in the pixel grayscale value of the at least one target pixel in the target region may conform to a change pattern of curve 1, curve 2 or curve 3.

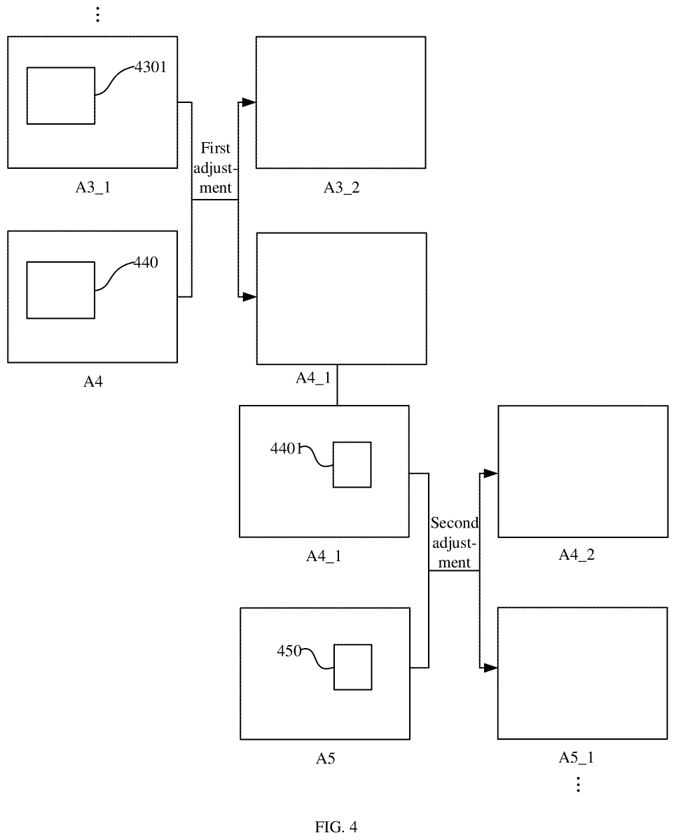

According to embodiments of the present disclosure, for example, in a case of adjusting the pixel grayscale value of the at least one target pixel in the target region according to curve 1 in FIG. 4 using the predetermined mapping relationship in Table 1, the multi-view images may have the maximum grayscale value of 255, the minimum grayscale value of 0 and the average grayscale value of 125. By looking up Table 1, it may be obtained that N1 is 20 and N2 is 90. Then, the pixel grayscale value equal to 0 in the target region may be adjusted to N1 of “20”, and the pixel grayscale value greater than 0 and less than or equal to 90 in the target region may be adjusted according to the change pattern of curve 1.

According to embodiments of the present disclosure, in a case of adjusting the pixel grayscale value in the target region according to the curve 1 in response to determining that the grayscale value of the at least one target pixel is greater than the first threshold value and less than or equal to the second threshold value, the first target value may be calculated according to Equation (1) corresponding to the curve 1.

$$Y 1 = ( N 2 - N 1 ) / N 2 * X + N 1 \qquad ( 1 )$$

where X represents the pixel grayscale value in the target region.

According to embodiments of the present disclosure, in a case of adjusting the pixel grayscale value in the target region according to the curve 2, the first target value may be calculated according to Equation (2) corresponding to the curve 2.

$$Y 1 = N 1 * N 2 * N 2 / ( ( N 1 - N 2 ) * X + N 2 * N 2 ) \qquad ( 2 )$$

According to embodiments of the present disclosure, in a case of adjusting the pixel grayscale value in the target region according to the curve 3, the first target value may be calculated according to Equation (3) corresponding to the curve 3.

$$Y 1 = \frac{N 1 * N 2 * ( {e}^{- \frac{N 2}{c}} - 1 )}{N 2 * ( {e}^{- \frac{N 2}{c}} - 1 ) - ( N 1 - N 2 ) + ( N 1 - N 2 ) * {e}^{- \frac{X}{c}}} \qquad ( 3 )$$

where c represents a predetermined constant.

According to embodiments of the present disclosure, in a case of adjusting the pixel grayscale value of the at least one target pixel in the target region in response to determining that the grayscale value of the at least one target pixel is greater than the first threshold value and less than or equal to the second threshold value, a specific adjustment equation may be determined according to actual service needs and is not limited herein.

According to embodiments of the present disclosure, the adjustment unit adjusting the pixel grayscale value of the at least one target pixel in the at least one target region may include: adjusting the grayscale value of the at least one target pixel to a third threshold value in response to determining that the grayscale value of the at least one target pixel is greater than or equal to the third threshold value; adjusting the grayscale value of the at least one target pixel to a second target value in response to determining that the grayscale value of the at least one target pixel is less than the third threshold value and greater than or equal to a fourth threshold value, where the second target value is determined according to the third threshold value and the fourth threshold value; and keeping the grayscale value of the at least one target pixel unchanged in response to determining that the grayscale value of the at least one target pixel is less than the fourth threshold value. The third threshold value and the fourth threshold value are determined according to the predetermined mapping relationship.

According to embodiments of the present disclosure, by adjusting the grayscale value of the at least one target pixel to the third threshold value in response to determining that the grayscale value of the at least one target pixel is greater than or equal to the third threshold value, it is possible to reduce a contrast of brightness at the same position of the parallax images by reducing the brightness of a high grayscale, so that the ghosting may be reduced when the parallax images are displayed on the display apparatus.

By adjusting the grayscale value of the at least one target pixel to the second target value determined according to the third threshold value and the fourth threshold value in response to determining that the grayscale value of the at least one target pixel is less than the third threshold value and greater than or equal to the fourth threshold value, it is possible to adjust the grayscale value of the at least one target pixel through the second target value determined by the third threshold value and the fourth threshold value, so that the grayscale value less than the third threshold value and greater than or equal to the fourth threshold value may be adjusted to slowly change according to a certain pattern, then the contrast of brightness at the same position of the parallax images may be slowly reduced, and the ghosting may be reduced when the parallax images are displayed on the display apparatus.

According to embodiments of the present disclosure, in a case of adjusting the pixel grayscale value in the target region using the third threshold value and the fourth threshold value, the pixel grayscale value in the target region may be adjusted according to an adjustment method similar to the change pattern in FIG. 2.

According to embodiments of the present disclosure, in a case of adjusting the pixel grayscale value in the target region using the third threshold value and the fourth threshold value in response to determining that the grayscale value of the at least one target pixel is less than the third threshold value and greater than or equal to the fourth threshold value, the second target value may be calculated according to Equation (4).

$$Y 2 = N 3 + ( X - N 3 ) / ( 255 - N 3 ) * ( N 4 - N 3 ) \qquad ( 4 )$$

According to embodiments of the present disclosure, in a case of adjusting the pixel grayscale value in the target region using the third threshold value and the fourth threshold value, the second target value may also be calculated according to Equation (5).

$$Y 2 = \frac{( 255 - {N}_{3} ) * {N}_{3} * {N}_{4}}{( {N}_{4} - {N}_{3} ) * ( 255 - X ) + ( 255 - {N}_{3} ) * {N}_{3}} \qquad ( 5 )$$

According to embodiments of the present disclosure, in a case of adjusting the pixel grayscale value in the target region using the third threshold value and the fourth threshold value, the second target value may also be calculated according to Equation (6).

$$Y 2 = \frac{{N}_{3} * {N}_{4} * ( {e}^{- \frac{255 - {N}_{3}}{c}} - 1 )}{{N}_{3} * ( {e}^{- \frac{255 - {N}_{3}}{c}} - 1 ) - ( {N}_{4} - {N}_{3} ) + ( {N}_{4} - {N}_{3} ) * {e}^{- \frac{255 - X}{c}}} \qquad ( 6 )$$

According to embodiments of the present disclosure, in a case of adjusting the pixel grayscale value in the target region using the third threshold value and the fourth threshold value in response to determining that the grayscale value of the at least one target pixel is less than the third threshold value and greater than or equal to the fourth threshold value, a specific adjustment equation may be determined according to the actual service needs and is not limited herein.

According to embodiments of the present disclosure, after the multi-view images are adjusted using the first threshold value and the second threshold value, the multi-view images may be further adjusted using the third threshold value and the fourth threshold value, so as to increase the brightness of a low grayscale and reduce the brightness of a high grayscale, thereby reducing the ghosting better when displaying the parallax images on the display apparatus.

According to embodiments of the present disclosure, Equation (1) to Equation (6) used to adjust the multi-view images may be selected according to actual service situation and are not limited herein.

According to embodiments of the present disclosure, the multi-view images include a first viewpoint image and a second viewpoint image adjacent to the first viewpoint image. The first viewpoint image contains N pixels, and the second viewpoint image contains N pixels, where N is an integer greater than 1.

According to embodiments of the present disclosure, the apparatus 100 of processing the image shown in FIG. 1 may further include a first determination unit. The first determination unit may be used to determine a first region in the first viewpoint image and a second region corresponding to the first region in the second viewpoint image according to difference values between the grayscale values of the N pixels of the first viewpoint image and the grayscale values of the N pixels of the second viewpoint image, and determine the first region and the second region as the at least one target region.

According to embodiments of the present disclosure, the first determination unit determining the first region in the first viewpoint image and the second region corresponding to the first region in the second viewpoint image according to the difference values between the grayscale values of the N pixels of the first viewpoint image and the grayscale values of the N pixels of the second viewpoint image may include: determining the difference values between the grayscale values of the N pixels of the first viewpoint image and the grayscale values of the N pixels of the second viewpoint image to obtain N difference values; and then determining the first region in the first viewpoint image and the second region corresponding to the first region in the second viewpoint image according to the N difference values. The first region and the second region each contain n adjacent pixels. The difference values between the pixel values of the n pixels in the first region and the pixel values of the n pixels in the second region are all greater than or equal to a predetermined difference threshold value, where n is greater than or equal to a predetermined number-of-pixels threshold value and less than N.

According to embodiments of the present disclosure, by determining the difference values between the grayscale values of the N pixels of the first viewpoint image and the grayscale values of the N pixels of the second viewpoint image to obtain N difference values and then determining the first region in the first viewpoint image and the second region corresponding to the first region in the second viewpoint image according to the N difference values, it is possible to more accurately determine the position of the first region and the second region with ghosting and subsequently only adjust the first region and the second region with ghosting, so that an adjustment efficiency may be improved.

According to embodiments of the present disclosure, a ghosting region may not be observed by human eyes until it reaches a certain area size. Therefore, when the first region and the second region each contain n adjacent pixels, the difference values between the pixel values of the n pixels in the first region and the pixel values of the n pixels in the second region are all greater than or equal to the predetermined difference threshold value, and n is greater than or equal to the predetermined number-of-pixels threshold value and less than N, it may be ensured that the first region and the second region are the ghosting region observable by human eyes, and the first region and the second region may be determined more accurately.

According to embodiments of the present disclosure, the predetermined difference threshold value and the predetermined number-of-pixels threshold value may be determined according to actual service needs and are not limited herein. For example, the predetermined number-of-pixels threshold value may be 5% to 10% of a total number of pixels in the multi-view images, and the predetermined difference threshold value may be 10, 20, or 30.

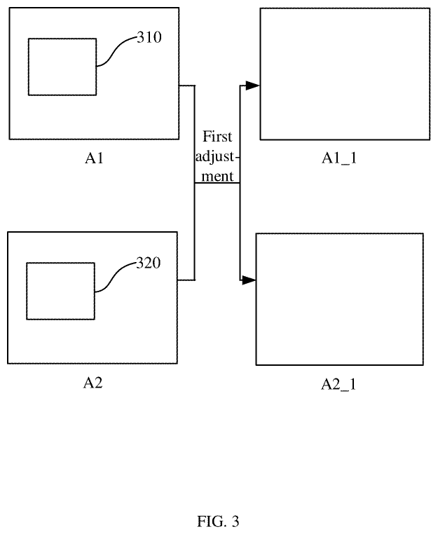

FIG. 3 shows a process of the apparatus of processing the image adjusting the multi-view images in a case that the multi-view images include two adjacent viewpoint images according to embodiments of the present disclosure.

As shown in FIG. 3, the multi-view images include a first viewpoint image A1 and a second viewpoint image A2 adjacent to the first viewpoint image A1.

By traversing all the pixels of the first viewpoint image A1 and the second viewpoint image A2, it is possible to obtain a matrix of absolute values of difference values between pixel grayscales at the same position of the second viewpoint image A2 and the left-side viewpoint image A1, then extract the position having a large value in the matrix of difference absolute values (a threshold value may be set), and then respectively extract large-area connected regions in the two matrix sets (a threshold value of the number of pixels connected together may be set) to obtain a first region 310 in the first viewpoint image A1 and a second region 320 in the second viewpoint image A2.

Then, the maximum grayscale value, the minimum grayscale value and the average grayscale value in the first region 310 and the second region 320 may be calculated. By looking up Table 1, N1, N2, N3 and N4 may be obtained. Then, a first adjustment is performed on the pixel grayscale values of the first region 310 and the second region 320 according to N1, N2, N3 and N4 by using Equation (1) and Equation (4), so as to obtain an adjusted first viewpoint image A1_1 and an adjusted second viewpoint image A2_1.

According to embodiments of the present disclosure, the multi-view images may also include M viewpoint images, where M is an integer greater than 2. The M viewpoint images may each contain N pixels.

According to embodiments of the present disclosure, the apparatus 100 of processing the image shown in FIG. 1 may further include a second determination unit. The second determination unit may be used to determine an m^{th} region in an m^{th} viewpoint image and an (m+1)^{th} region corresponding to the m^{th} region in an (m+1)^{th} viewpoint image according to difference values between the grayscale values of the N pixels of the m^{th} viewpoint image and the grayscale values of the N pixels of the (m+1)^{th} viewpoint image, and determine the m^{th} region and the (m+1)^{th} region as the at least one target region, so as to obtain an adjusted m^{th} viewpoint image and an adjusted (m+1)^{th} viewpoint image. m is greater than or equal to 1 and less than or equal to M−2.

An adjusted (m+1)^{th} region in the adjusted (m+1)^{th} viewpoint image and an (m+2)^{th} region corresponding to the adjusted (m+1)^{th} region in an (m+2)^{th} viewpoint image may be determined according to the difference values between the grayscale values of the N pixels of the adjusted (m+1)^{th} viewpoint image and the grayscale values of the N pixels of the (m+2)^{th} viewpoint image, and the adjusted (m+1)^{th} region and the (m+2)^{th} region may be determined as the at least one target region.

According to embodiments of the present disclosure, the second determination unit determining the m^{th} region in the m^{th} viewpoint image and the (m+1)^{th} region corresponding to the m^{th} region in the (m+1)^{th} viewpoint image according to the difference values between the grayscale values of the N pixels of the m^{th} viewpoint image and the grayscale values of the N pixels of the (m+1)^{th} viewpoint image may include: determining the difference values between the grayscale values of the N pixels of the m^{th} viewpoint image and the grayscale values of the N pixels of the (m+1)^{th} viewpoint image to obtain N difference values; determining the m^{th} region in the m^{th} viewpoint image and the (m+1)^{th} region corresponding to the m^{th} region in the (m+1)^{th} viewpoint image according to the N difference values. The m^{th} region and the (m+1)^{th} region each contain n adjacent pixels. The difference values between the pixel values of the n pixels in the m^{th} region and the pixel values of the n pixels in the (m+1)^{th} region are all greater than or equal to a predetermined difference threshold value, and n is greater than or equal to a predetermined number-of-pixels threshold value and less than N.

According to embodiments of the present disclosure, M may be determined according to actual service needs and is not limited herein. For example, M may be 3, 6, or 9, etc.

According to embodiments of the present disclosure, by determining the difference values between the grayscale values of the N pixels of the m^{th} viewpoint image and the grayscale values of the N pixels of the (m+1)^{th} viewpoint image to obtain N difference values and then determining the m^{th} region in the m^{th} viewpoint image and the (m+1)^{th} region corresponding to the m^{th} region in the (m+1)^{th} viewpoint image according to the N difference values, it is possible to more accurately determine the position of the m^{th} region and the (m+1)^{th} region with ghosting and subsequently only perform an adjustment on the m^{th} region and the (m+1)^{th} region with ghosting, so that the adjustment efficiency may be improved.

According to embodiments of the present disclosure, the ghosting region may not be observed by human eyes until it reaches a certain area size. Therefore, when the m^{th} region and the (m+1)^{th} region each contain n adjacent pixels, the difference values between the pixel values of the n pixels in the m^{th} region and the pixel values of the n pixels in the (m+1)^{th} region are all greater than or equal to the predetermined difference threshold value, and n is greater than or equal to the predetermined number-of-pixels threshold value and less than N, it may be ensured that the m^{th} region and the (m+1)^{th} region are the ghosting region observable by human eyes, and the m^{th} region and the (m+1)^{th} region may be determined more accurately.

FIG. 4 shows a process of the apparatus of processing the image adjusting the multi-view images in a case that the multi-view images include at least three viewpoint images according to embodiments of the present disclosure.

According to embodiments of the present disclosure, the multi-view images shown in FIG. 4 may include nine viewpoint images. The nine viewpoint images include a third viewpoint image A3, a fourth viewpoint image A4, and a fifth viewpoint image A5.

As shown in FIG. 4, the step of adjusting the nine viewpoint images by the second determination unit may include: traversing all pixels of the plurality of viewpoint images A1 to A9 to obtain a matrix of absolute values of difference values between pixel grayscales at the same position of the target viewpoint image such as A2 and the left-side viewpoint image such as A1 (in a case of no left-side viewpoint image or right-side viewpoint image, it is possible to obtain only one difference matrix, for example, A1 is only adjacent to the viewpoint image A2, and A9 is only adjacent to the viewpoint image A8), then extracting the position having a large value in the matrix of difference absolute values (a threshold value may be set), and then respectively extracting large-area connected regions in the two matrix sets (a threshold value of the number of pixels connected together may be set) to obtain a region a1 in the A1 and a region a2 in the A2.

Then, the above calculations (i.e., reducing a too high grayscale value and increasing a too low grayscale value) are performed on the pixel grayscale values in the region a1 and the region a2 to obtain an adjusted A1 and an adjusted A2, and then the pixel difference values between the adjusted A2 and the original A3 are calculated to obtain a target region a2′ in the A2 and a target region a3 in the A3. It should be noted that the target region a2′ is independent with the target region a2. Next, the pixel grayscale values in the target region a2′ and the target region a3 in the A3 are adjusted to obtain a further adjusted A2 and an adjusted A3. Then, the pixel difference values between the adjusted A3 and the original A4 are calculated.

As shown in FIG. 4, the adjusted A3 is “A3_1”. The second determination unit calculates a pixel difference between the A3_1 and the original A4 to obtain a target region 4301 in the A3_1 and a target region 440 in the A4. Then a first adjustment of pixel grayscale value is performed on the target region 4301 and the target region 440 to obtain a further adjusted A3, i.e., “A3_2”, and an adjusted A4, i.e., “A4_1”. Then the pixel difference value between the A4_1 and the A5 is calculated to obtain a target region 450 in the A4_1 and a target region 4401 in the A4_1. A second adjustment of pixel grayscale value is performed on the target region 450 and the target region 4401 to obtain a further adjusted A4_1, i.e., “A4_2”, and an adjusted A5, i.e., “A5_1”. Then, the pixel difference values between the A5_1 and the original A6 are calculated, and so on.

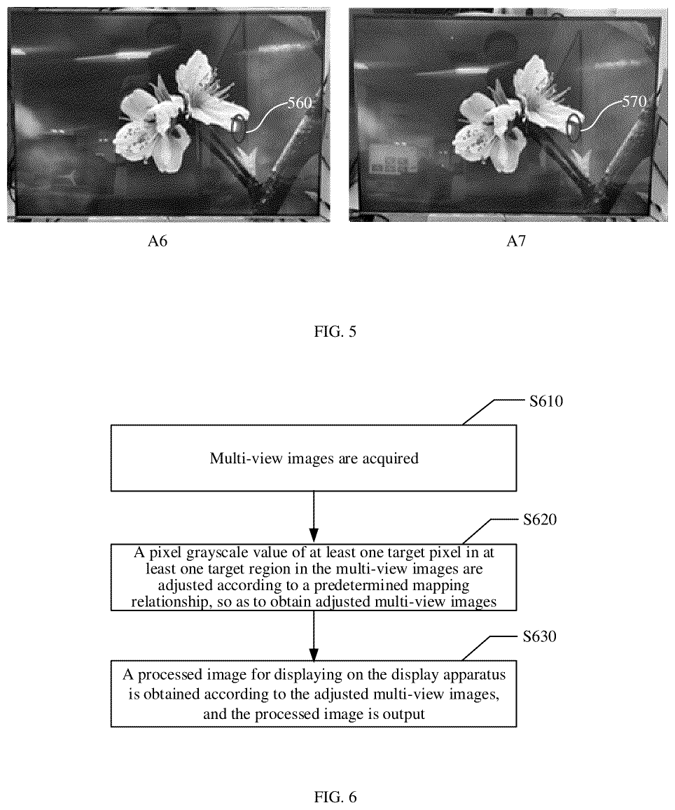

FIG. 5 shows an image displayed by a display apparatus according to embodiments of the present disclosure.

Firstly, a maximum grayscale value, a minimum grayscale value and an average grayscale value are calculated for adjacent viewpoint images corresponding to an integral image A6 in FIG. 5. Then, it is obtained that N1 is 30 and N2 is 127 by looking up Table 1 according to the maximum grayscale value, the minimum grayscale value and the average grayscale value. The pixel difference values between the adjacent viewpoint images corresponding to the integral image A6 are calculated to obtain a target region of 560. The adjacent viewpoint images corresponding to the integral image A6 are adjusted using Equation (1) to obtain adjusted viewpoint images, and then obtain an integral image A7. The target region 560 is adjusted to obtain an adjusted target region 570.

As shown in FIG. 5, the ghosting of the target region 570 is significantly smaller than that of the target region 560, which proves that the apparatus of processing the image in the present disclosure may accurately and quickly adjust the target region 560 and may effectively reduce the ghosting.

According to embodiments of the present disclosure, the output unit obtaining the processed image for displaying on a display apparatus according to the adjusted plurality of viewpoint images may include: concatenating the adjusted multi-view images to obtain the processed image for displaying on the display apparatus.

The display device provided in embodiments of the present disclosure may include the apparatus of processing the image provided in embodiments of the present disclosure and a display apparatus. The display apparatus may be used to display an output image from the apparatus of processing the image.

FIG. 6 shows a flowchart of a method of processing an image according to embodiments of the present disclosure.

As shown in FIG. 6, the method of processing the image in such embodiments may include operations S610 to S630.

In operation S610, multi-view images are acquired.

In operation S620, a pixel grayscale value of at least one target pixel in at least one target region in the multi-view images is adjusted according to a predetermined mapping relationship, so as to obtain adjusted multi-view images, where the predetermined mapping relationship is obtained by measuring a ghosting sensitivity of a display apparatus.

In operation S630, a processed image for displaying on the display apparatus is obtained according to the adjusted multi-view images, and the processed image is output.

It should be noted that operations shown in the flowcharts in embodiments of the present disclosure may be executed in a non-sequential manner or may be executed simultaneously, unless a sequence of execution of different operations or a sequence of execution of different operations in terms of technical implementation is clearly stated.

It should also be noted that the method of processing the image in embodiments of the present disclosure corresponds to the part of the apparatus of processing the image in embodiments of the present disclosure, and will not be repeated here.

According to embodiments of the present disclosure, the multi-view images include a first viewpoint image and a second viewpoint image adjacent to the first viewpoint image, the first viewpoint image contains N pixels, the second viewpoint image contains N pixels, and N is an integer greater than 1.

The method of processing the image further includes: determining a first region in the first viewpoint image and a second region corresponding to the first region in the second viewpoint image according to difference values between grayscale values of the N pixels of the first viewpoint image and grayscale values of the N pixels of the second viewpoint image; and determining the first region and the second region as the at least one target region.

According to embodiments of the present disclosure, the determining a first region in the first viewpoint image and a second region corresponding to the first region in the second viewpoint image according to difference values between grayscale values of the N pixels of the first viewpoint image and grayscale values of the N pixels of the second viewpoint image includes: determining the difference values between the grayscale values of the N pixels of the first viewpoint image and the grayscale values of the N pixels of the second viewpoint image to obtain N difference values; and determining the first region in the first viewpoint image and the second region corresponding to the first region in the second viewpoint image according to the N difference values, where the first region and the second region each contain n adjacent pixels, each of the difference values between the pixel values of the n pixels in the first region and the pixel values of the n pixels in the second region is greater than or equal to a predetermined difference threshold value, and n is greater than or equal to a predetermined number-of-pixels threshold value and less than N.

According to embodiments of the present disclosure, the multi-view images include M viewpoint images, M is an integer greater than 2; each of the M viewpoint images contains N pixels.

The method of processing the image further includes: determining an m^{th} region in an m^{th} viewpoint image and an (m+1)^{th} region corresponding to the m^{th} region in an (m+1)^{th} viewpoint image according to difference values between the grayscale values of the N pixels of the m^{th} viewpoint image and the grayscale values of the N pixels of the (m+1)^{th} viewpoint image, and determining the m^{th} region and the (m+1)^{th} region as the at least one target region, so as to obtain an adjusted m^{th} viewpoint image and an adjusted (m+1)^{th} viewpoint image, where m is greater than or equal to 1 and less than or equal to M−2; and determining an adjusted (m+1)^{th} region in the adjusted (m+1)^{th} viewpoint image and an (m+2)^{th} region corresponding to the adjusted (m+1)^{th} region in an (m+2)^{th} viewpoint image according to difference values between the grayscale values of the N pixels of the adjusted (m+1)^{th} viewpoint image and the grayscale values of the N pixels of the (m+2)^{th} viewpoint image, and determining the adjusted (m+1)^{th} region and the (m+2)^{th} region as the at least one target region.

According to embodiments of the present disclosure, the determining an m^{th} region in an m^{th} viewpoint image and an (m+1)^{th} region corresponding to the m^{th} region in an (m+1)^{th} viewpoint image according to difference values between the grayscale values of the N pixels of the m^{th} viewpoint image and the grayscale values of the N pixels of the (m+1)^{th} viewpoint image includes: determining the difference values between the grayscale values of the N pixels of the m^{th} viewpoint image and the grayscale values of the N pixels of the (m+1)^{th} viewpoint image to obtain N difference values; and determining the m^{th} region in the m^{th} viewpoint image and the (m+1)^{th} region corresponding to the m^{th} region in the (m+1)^{th} viewpoint image according to the N difference values, where the m^{th} region and the (m+1)^{th} region each contain n adjacent pixels, each of the difference values between the pixel values of the n pixels in the m^{th} region and the pixel values of the n pixels in the (m+1)^{th} region is greater than or equal to a predetermined difference threshold value, and n is greater than or equal to a predetermined number-of-pixels threshold value and less than N.

According to embodiments of the present disclosure, the adjusting a pixel grayscale value of at least one target pixel in at least one target region includes: adjusting the grayscale value of the at least one target pixel to a first threshold value in response to determining that the grayscale value of the at least one target pixel is less than or equal to the first threshold value; adjusting the grayscale value of the at least one target pixel to a first target value in response to determining that the grayscale value of the at least one target pixel is greater than the first threshold value and less than or equal to a second threshold value, where the first target value is determined according to the first threshold value and the second threshold value; and keeping the grayscale value of the at least one target pixel unchanged in response to determining that the grayscale value of the at least one target pixel is greater than the second threshold value, where the first threshold value and the second threshold value are determined according to the predetermined mapping relationship.

According to embodiments of the present disclosure, the adjusting a pixel grayscale value of at least one target pixel in at least one target region includes: adjusting the grayscale value of the at least one target pixel to a third threshold value in response to determining that the grayscale value of the at least one target pixel is greater than or equal to the third threshold value; adjusting the grayscale value of the at least one target pixel to a second target value in response to determining that the grayscale value of the at least one target pixel is less than the third threshold value and greater than or equal to a fourth threshold value, where the second target value is determined according to the third threshold value and the fourth threshold value; and keeping the grayscale value of the at least one target pixel unchanged in response to determining that the grayscale value of the at least one target pixel is less than the fourth threshold value, where the third threshold value and the fourth threshold value are determined according to the predetermined mapping relationship.

According to embodiments of the present disclosure, the obtaining, according to the adjusted multi-view images, a processed image for displaying on the display apparatus includes: concatenating the adjusted multi-view images to obtain the processed image for displaying on the display apparatus.

According to embodiments of the present disclosure, the predetermined mapping relationship includes a mapping relationship between the grayscale values of the pixels in the target region and a plurality of threshold values, the grayscale values of the pixels includes a maximum grayscale value, a minimum grayscale value and an average grayscale value of the pixels in the target region, and the plurality of threshold values include a first threshold value, a second threshold value, a third threshold value and a fourth threshold value.

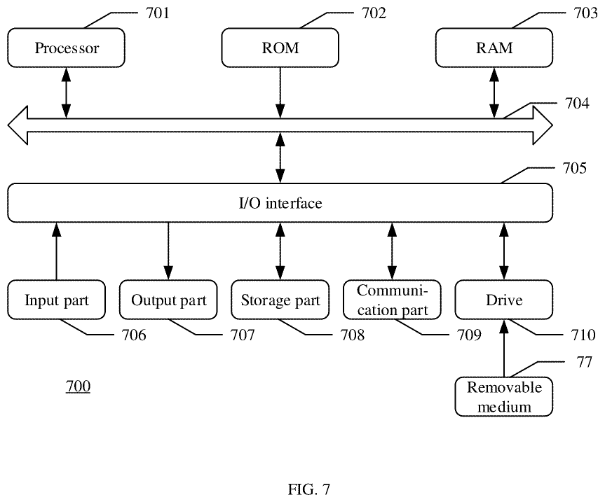

FIG. 7 shows a block diagram of an electronic device suitable for implementing a method of processing an image according to embodiments of the present disclosure.

As shown in FIG. 7, an electronic device 700 according to embodiments of the present disclosure includes a processor 701, which may execute various appropriate actions and processing according to the program stored in a read only memory (ROM) 702 or the program loaded into a random access memory (RAM) 703 from a storage part 708. The processor 701 may, for example, include a general-purpose microprocessor (for example, CPU), an instruction set processor and/or a related chipset and/or a special-purpose microprocessor (for example, an application specific integrated circuit (ASIC)), and the like. The processor 701 may further include an on-board memory for caching purposes. The processor 701 may include a single processing unit or multiple processing units for executing different actions of the method flow according to embodiments of the present disclosure.

Various programs and data required for the operation of the device 700 are stored in the RAM 703. The processor 701, the ROM 702 and the RAM 703 are connected to each other through a bus 704. The processor 701 executes various operations of the method flow according to embodiments of the present disclosure by executing the programs in the ROM 702 and/or the RAM 703. It should be noted that the program may also be stored in one or more memories other than the ROM 702 and the RAM 703. The processor 701 may also execute various operations of the method flow according to embodiments of the present disclosure by executing the programs stored in the one or more memories.

According to embodiments of the present disclosure, the electronic device 700 may further include an input/output (I/O) interface 705 which is also connected to the bus 704. The device 700 may further include one or more of the following components connected to the I/O interface 705: an input part 706 including a keyboard, a mouse, etc.; an output part 707 including a cathode ray tube (CRT), a liquid crystal display (LCD), etc. and a speaker, etc.; a storage part 708 including a hard disk, etc.; and a communication part 709 including a network interface card such as a LAN card, a modem, and the like. The communication part 709 performs communication processing via a network such as the Internet. A drive 710 is also connected to the I/O interface 705 as required. A removable medium 711, such as a magnetic disk, an optical disk, a magneto-optical disk, a semiconductor memory, and the like, is installed on the drive 710 as required, so that the computer program read therefrom is installed into the storage part 708 as needed.

The present disclosure further provides a computer-readable storage medium, which may be included in the apparatus/device/system described in the above embodiments; or exist alone without being assembled into the apparatus/device/system. The above-mentioned computer-readable storage medium carries one or more programs that when executed, perform the methods according to embodiments of the present disclosure.

According to embodiments of the present disclosure, the computer-readable storage medium may be a non-transitory computer-readable storage medium, for example, may include but not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In the present disclosure, the computer-readable storage medium may be any tangible medium that contains or stores programs that may be used by or in combination with an instruction execution system, apparatus or device. For example, according to embodiments of the present disclosure, the computer-readable storage medium may include the above-mentioned ROM 702 and/or RAM 703 and/or one or more memories other than the ROM 702 and RAM 703.

Embodiments of the present disclosure further include a computer program product, which contains a computer program. The computer program contains program code for performing the method shown in the flowcharts. When the computer program product runs on a computer system, the program code causes the computer system to implement the method of processing the image provided in embodiments of the present disclosure.

When the computer program is executed by the processor 701, the above-mentioned functions defined in the system/apparatus of embodiments of the present disclosure are performed. According to embodiments of the present disclosure, the above-described systems, apparatuses, modules, units, etc. may be implemented by computer program modules.

In an embodiment, the computer program may rely on a tangible storage medium such as an optical storage device and a magnetic storage device. In another embodiment, the computer program may also be transmitted and distributed in the form of signals on a network medium, downloaded and installed through the communication part 709, and/or installed from the removable medium 711. The program code contained in the computer program may be transmitted by any suitable medium, including but not limited to a wireless one, a wired one, or any suitable combination of the above.

In such embodiments, the computer program may be downloaded and installed from the network through the communication part 709, and/or installed from the removable medium 711. When the computer program is executed by the processor 701, the above-mentioned functions defined in the system of embodiments of the present disclosure are performed. According to embodiments of the present disclosure, the above-described systems, apparatuses, devices, modules, units, etc. may be implemented by computer program modules.

According to embodiments of the present disclosure, the program code for executing the computer programs provided by embodiments of the present disclosure may be written in any combination of one or more programming languages. In particular, these computing programs may be implemented using high-level procedures and/or object-oriented programming languages, and/or assembly/machine languages. Programming languages include, but are not limited to, Java, C++, Python, “C” language or similar programming languages. The program code may be completely executed on the user computing device, partially executed on the user device, partially executed on the remote computing device, or completely executed on the remote computing device or server. In a case of involving a remote computing device, the remote computing device may be connected to a user computing device through any kind of network, including a local area network (LAN) or a wide area networks (WAN), or may be connected to an external computing device (e.g., through the Internet using an Internet service provider).

The flowcharts and block diagrams in the accompanying drawings illustrate the possible architecture, functions, and operations of the system, method, and computer program product according to various embodiments of the present disclosure. In this regard, each block in the flowcharts or block diagrams may represent a part of a module, a program segment, or a code, which part includes one or more executable instructions for implementing the specified logical function. It should be further noted that, in some alternative implementations, the functions noted in the blocks may also occur in a different order from that noted in the accompanying drawings. For example, two blocks shown in succession may actually be executed substantially in parallel, or they may sometimes be executed in a reverse order, depending on the functions involved. It should be further noted that each block in the block diagrams or flowcharts, and the combination of blocks in the block diagrams or flowcharts, may be implemented by a dedicated hardware-based system that performs the specified functions or operations, or may be implemented by a combination of dedicated hardware and computer instructions.

Those skilled in the art may understand that the various embodiments of the present disclosure and/or the features described in the claims may be combined in various ways, even if such combinations are not explicitly described in the present disclosure. In particular, without departing from the spirit and teachings of the present disclosure, the various embodiments of the present disclosure and/or the features described in the claims may be combined in various ways. All these combinations fall within the scope of the present disclosure.

Embodiments of the present disclosure have been described above. However, these embodiments are for illustrative purposes only, and are not intended to limit the scope of the present disclosure. Although the various embodiments have been described separately above, this does not mean that measures in the respective embodiments may not be used in combination advantageously. The scope of the present disclosure is defined by the appended claims and their equivalents. Those skilled in the art may make various substitutions and modifications without departing from the scope of the present disclosure, and these substitutions and modifications should all fall within the scope of the present disclosure.

1. An apparatus of processing an image, comprising:
an acquisition unit configured to acquire multi-view images;
an adjustment unit configured to adjust a pixel grayscale value of at least one target pixel in at least one target region in the multi-view images according to a predetermined mapping relationship, so as to obtain adjusted multi-view images, wherein the predetermined mapping relationship is obtained by measuring a ghosting sensitivity of a display apparatus; and
an output unit configured to obtain, according to the adjusted multi-view images, a processed image for displaying on the display apparatus, and output the processed image.

2. The apparatus according to claim 1, wherein the multi-view images comprise a first viewpoint image and a second viewpoint image adjacent to the first viewpoint image, the first viewpoint image contains N pixels, the second viewpoint image contains N pixels, and N is an integer greater than 1; and
wherein the apparatus further comprises a first determination unit configured to: determine a first region in the first viewpoint image and a second region corresponding to the first region in the second viewpoint image according to difference values between grayscale values of the N pixels of the first viewpoint image and grayscale values of the N pixels of the second viewpoint image, and determine the first region and the second region as the at least one target region.

3. The apparatus according to claim 2, wherein the first determination unit being configured to determine a first region in the first viewpoint image and a second region corresponding to the first region in the second viewpoint image according to difference values between grayscale values of the N pixels of the first viewpoint image and grayscale values of the N pixels of the second viewpoint image comprises:
determining the difference values between the grayscale values of the N pixels of the first viewpoint image and the grayscale values of the N pixels of the second viewpoint image to obtain N difference values; and
determining the first region in the first viewpoint image and the second region corresponding to the first region in the second viewpoint image according to the N difference values, wherein the first region and the second region each contain n adjacent pixels, each of the difference values between the pixel values of the n pixels in the first region and the pixel values of the n pixels in the second region is greater than or equal to a predetermined difference threshold value, and n is greater than or equal to a predetermined number-of-pixels threshold value and less than N.

4. The apparatus according to claim 1, wherein the multi-view images comprise M viewpoint images, M is an integer greater than 2; each of the M viewpoint images contains N pixels; and
wherein the apparatus further comprises a second determination unit configured to:
determine an m^{th} region in an m^{th} viewpoint image and an (m+1)^{th} region corresponding to the m^{th} region in an (m+1)^{th} viewpoint image according to difference values between the grayscale values of the N pixels of the m^{th} viewpoint image and the grayscale values of the N pixels of the (m+1)^{th} viewpoint image, and determine the m^{th} region and the (m+1)^{th} region as the at least one target region, so as to obtain an adjusted m^{th} viewpoint image and an adjusted (m+1)^{th} viewpoint image, where m is greater than or equal to 1 and less than or equal to M−2; and
determine an adjusted (m+1)^{th} region in the adjusted (m+1)^{th} viewpoint image and an (m+2)^{th} region corresponding to the adjusted (m+1)^{th} region in an (m+2)^{th} viewpoint image according to difference values between the grayscale values of the N pixels of the adjusted (m+1)^{th} viewpoint image and the grayscale values of the N pixels of the (m+2)^{th} viewpoint image, and determine the adjusted (m+1)^{th} region and the (m+2)^{th} region as the at least one target region.

5. The apparatus according to claim 4, wherein the second determination unit being configured to determine an m^{th} region in an m^{th} viewpoint image and an (m+1)^{th} region corresponding to the m^{th} region in an (m+1)^{th} viewpoint image according to difference values between the grayscale values of the N pixels of the m^{th} viewpoint image and the grayscale values of the N pixels of the (m+1)^{th} viewpoint image comprises:
determining the difference values between the grayscale values of the N pixels of the m^{th} viewpoint image and the grayscale values of the N pixels of the (m+1)^{th} viewpoint image to obtain N difference values; and
determining the m^{th} region in the m^{th} viewpoint image and the (m+1)^{th} region corresponding to the m^{th} region in the (m+1)^{th} viewpoint image according to the N difference values, wherein the m^{th} region and the (m+1)^{th} region each contain n adjacent pixels, each of the difference values between the pixel values of the n pixels in the m^{th} region and the pixel values of the n pixels in the (m+1)^{th} region is greater than or equal to a predetermined difference threshold value, and n is greater than or equal to a predetermined number-of-pixels threshold value and less than N.

6. The apparatus according to claim 1, wherein the adjustment unit being configured to adjust a pixel grayscale value of at least one target pixel in at least one target region comprises:
adjusting the grayscale value of the at least one target pixel to a first threshold value in response to determining that the grayscale value of the at least one target pixel is less than or equal to the first threshold value;
adjusting the grayscale value of the at least one target pixel to a first target value in response to determining that the grayscale value of the at least one target pixel is greater than the first threshold value and less than or equal to a second threshold value, wherein the first target value is determined according to the first threshold value and the second threshold value; and
keeping the grayscale value of the at least one target pixel unchanged in response to determining that the grayscale value of the at least one target pixel is greater than the second threshold value,
wherein the first threshold value and the second threshold value are determined according to the predetermined mapping relationship.

7. The apparatus according to claim 1, wherein the adjustment unit being configured to adjust a pixel grayscale value of at least one target pixel in at least one target region comprises:
adjusting the grayscale value of the at least one target pixel to a third threshold value in response to determining that the grayscale value of the at least one target pixel is greater than or equal to the third threshold value;
adjusting the grayscale value of the at least one target pixel to a second target value in response to determining that the grayscale value of the at least one target pixel is less than the third threshold value and greater than or equal to a fourth threshold value, wherein the second target value is determined according to the third threshold value and the fourth threshold value; and
keeping the grayscale value of the at least one target pixel unchanged in response to determining that the grayscale value of the at least one target pixel is less than the fourth threshold value,
wherein the third threshold value and the fourth threshold value are determined according to the predetermined mapping relationship.

8. The apparatus according to claim 1, wherein the output unit being configured to obtain, according to the adjusted multi-view images, a processed image for displaying on the display apparatus comprises:
concatenating the adjusted multi-view images to obtain the processed image for displaying on the display apparatus.

9. The apparatus according to claim 1, wherein the predetermined mapping relationship comprises a mapping relationship between the grayscale values of the pixels in the target region and a plurality of threshold values, the grayscale values of the pixels comprises a maximum grayscale value, a minimum grayscale value and an average grayscale value of the pixels in the target region, and the plurality of threshold values comprise a first threshold value, a second threshold value, a third threshold value and a fourth threshold value.

10. A display device, comprising:
the apparatus of processing the image according to claim 1; and
a display apparatus configured to display an output image from the apparatus of processing the image.

11. A method of processing an image, comprising:
acquiring multi-view images;
adjusting a pixel grayscale value of at least one target pixel in at least one target region in the multi-view images according to a predetermined mapping relationship, so as to obtain adjusted multi-view images, wherein the predetermined mapping relationship is obtained by measuring a ghosting sensitivity of a display apparatus;
obtaining, according to the adjusted multi-view images, a processed image for displaying on the display apparatus; and
outputting the processed image.

12. The method according to claim 11, wherein the multi-view images comprise a first viewpoint image and a second viewpoint image adjacent to the first viewpoint image, the first viewpoint image contains N pixels, the second viewpoint image contains N pixels, and N is an integer greater than 1; and
the method further comprises:
determining a first region in the first viewpoint image and a second region corresponding to the first region in the second viewpoint image according to difference values between grayscale values of the N pixels of the first viewpoint image and grayscale values of the N pixels of the second viewpoint image; and
determining the first region and the second region as the at least one target region.

13. The method according to claim 12, wherein the determining a first region in the first viewpoint image and a second region corresponding to the first region in the second viewpoint image according to difference values between grayscale values of the N pixels of the first viewpoint image and grayscale values of the N pixels of the second viewpoint image comprises:
determining the difference values between the grayscale values of the N pixels of the first viewpoint image and the grayscale values of the N pixels of the second viewpoint image to obtain N difference values; and
determining the first region in the first viewpoint image and the second region corresponding to the first region in the second viewpoint image according to the N difference values, wherein the first region and the second region each contain n adjacent pixels, each of the difference values between the pixel values of the n pixels in the first region and the pixel values of the n pixels in the second region is greater than or equal to a predetermined difference threshold value, and n is greater than or equal to a predetermined number-of-pixels threshold value and less than N.

14. The method according to claim 11, wherein the multi-view images comprise M viewpoint images, M is an integer greater than 2; each of the M viewpoint images contains N pixels; and
wherein the method further comprises:
determining an m^{th} region in an m^{th} viewpoint image and an (m+1)^{th} region corresponding to the m^{th} region in an (m+1)^{th} viewpoint image according to difference values between the grayscale values of the N pixels of the m^{th} viewpoint image and the grayscale values of the N pixels of the (m+1)^{th} viewpoint image, and determining the m^{th} region and the (m+1)^{th} region as the at least one target region, so as to obtain an adjusted m^{th} viewpoint image and an adjusted (m+1)^{th} viewpoint image, where m is greater than or equal to 1 and less than or equal to M−2; and
determining an adjusted (m+1)^{th} region in the adjusted (m+1)^{th} viewpoint image and an (m+2)^{th} region corresponding to the adjusted (m+1)^{th} region in an (m+2)^{th} viewpoint image according to difference values between the grayscale values of the N pixels of the adjusted (m+1)^{th} viewpoint image and the grayscale values of the N pixels of the (m+2)^{th} viewpoint image, and determining the adjusted (m+1)^{th} region and the (m+2)^{th} region as the at least one target region.

15. The method according to claim 14, wherein the determining an m^{th} region in an m^{th} viewpoint image and an (m+1)^{th} region corresponding to the m^{th} region in an (m+1)^{th} viewpoint image according to difference values between the grayscale values of the N pixels of the m^{th} viewpoint image and the grayscale values of the N pixels of the (m+1)^{th} viewpoint image comprises:
determining the difference values between the grayscale values of the N pixels of the m^{th} viewpoint image and the grayscale values of the N pixels of the (m+1)^{th} viewpoint image to obtain N difference values; and
determining the m^{th} region in the m^{th} viewpoint image and the (m+1)^{th} region corresponding to the m^{th} region in the (m+1)^{th} viewpoint image according to the N difference values, wherein the m^{th} region and the (m+1)^{th} region each contain n adjacent pixels, each of the difference values between the pixel values of the n pixels in the m^{th} region and the pixel values of the n pixels in the (m+1)^{th} region is greater than or equal to a predetermined difference threshold value, and n is greater than or equal to a predetermined number-of-pixels threshold value and less than N.

16. The method according to claim 11, wherein the adjusting a pixel grayscale value of at least one target pixel in at least one target region comprises:
adjusting the grayscale value of the at least one target pixel to a first threshold value in response to determining that the grayscale value of the at least one target pixel is less than or equal to the first threshold value;
adjusting the grayscale value of the at least one target pixel to a first target value in response to determining that the grayscale value of the at least one target pixel is greater than the first threshold value and less than or equal to a second threshold value, wherein the first target value is determined according to the first threshold value and the second threshold value; and
keeping the grayscale value of the at least one target pixel unchanged in response to determining that the grayscale value of the at least one target pixel is greater than the second threshold value,
wherein the first threshold value and the second threshold value are determined according to the predetermined mapping relationship.

17. The method according to claim 11, wherein the adjusting a pixel grayscale value of at least one target pixel in at least one target region comprises:
adjusting the grayscale value of the at least one target pixel to a third threshold value in response to determining that the grayscale value of the at least one target pixel is greater than or equal to the third threshold value;
adjusting the grayscale value of the at least one target pixel to a second target value in response to determining that the grayscale value of the at least one target pixel is less than the third threshold value and greater than or equal to a fourth threshold value, wherein the second target value is determined according to the third threshold value and the fourth threshold value; and
keeping the grayscale value of the at least one target pixel unchanged in response to determining that the grayscale value of the at least one target pixel is less than the fourth threshold value,
wherein the third threshold value and the fourth threshold value are determined according to the predetermined mapping relationship.

18. The method according to claim 11, wherein the obtaining, according to the adjusted multi-view images, a processed image for displaying on the display apparatus comprises:
concatenating the adjusted multi-view images to obtain the processed image for displaying on the display apparatus,
wherein the predetermined mapping relationship comprises a mapping relationship between the grayscale values of the pixels in the target region and a plurality of threshold values, the grayscale values of the pixels comprises a maximum grayscale value, a minimum grayscale value and an average grayscale value of the pixels in the target region, and the plurality of threshold values comprise a first threshold value, a second threshold value, a third threshold value and a fourth threshold value.

19. (canceled)

20. An electronic device, comprising:
at least one processor; and
a memory for storing instructions executable by the at least one processor, wherein the instructions are configured to, when executed by the at least one processor, cause the at least one processor to implement the method of claim 1.

21. A non-transitory computer-readable storage medium having computer instructions therein, wherein the computer instructions are configured to cause a computer to implement the method of claim 1.

22. (canceled)
